(19) United States
(12) Patent Application Publication
(10) Pub. No.: US 2004/0215747 A1
(43) Pub. Date: Oct. 28, 2004

(54) System and method for a configuration repository

(76) Inventor: Jonathan Maron, Marlton, NJ (US)

Correspondence Address: HEWLETT-PACKARD COMPANY, Intellectual Property Administration, P.O. Box 272400, Fort Collins, CO, 80527-2400, US

(21) Appl. No.: 10/412,134

(22) Filed: Apr. 11, 2003

(51) Int. Cl. G06F 15/16; G06F 15/177; G06F 7/00

(52) U.S. Cl. 709/220; 709/203; 707/10

(57) ABSTRACT

Disclosed are systems and methods for providing configuration information to an application server comprising a server, wherein the server includes web-based distributed authoring and versioning (WebDAV) compatibility, a configuration database disposed on the server, wherein the configuration database stores the configuration information, and a communication interface for facilitating communication between the configuration database and the application server, wherein the application server includes instructions for accessing the configuration database for retrieving configuration information.

### BACKGROUND

Clustering has become an accepted and integral practice to increase reliability and availability of Internet applications through load balancing and high-traffic management. Clustering is generally the use of multiple computers, typically personal computers (PCs), workstations, multiple storage devices, redundant interconnections, and the like, to form what appears to users as a single, highly available system. Applications and other processing duties are generally distributed across the multiple computers to either share the processing duties, as in parallel processing, and/or share hosting duties, as in hosting multiple instances of a particular Web site or web service on the multiple computers.

A common use of clustering is to load balance traffic on high-traffic Web sites. A Web page request is generally sent to a “manager” server, which then determines which of several closely identical or very similar Web servers to forward the request to for handling. Having such a Web farm or collection allows traffic to be handled more quickly and efficiently. Clustering may also typically be used as a relatively low-cost form of parallel processing for applications that may benefit from such high processing power, such as scientific applications and the like.

Hosting multiple application servers in a clustered environment having multiple platforms creates issues in maintaining the configuration across the multiple computers and platforms. Management of these configuration issues is generally difficult and has typically been performed using complex proprietary management systems. These proprietary systems have generally included technologies, such as peer-to-peer mechanisms, large, dedicated management servers responsible for interacting with all of the application servers and supplying the configuration, or the like. Therefore, if an application server goes down, it may go down permanently until the situation is noticed and then the configuration is shifted back to the inactive server.

### BRIEF SUMMARY

Representative embodiments are directed to a system for providing configuration information to an application server comprising a server, wherein the server includes web-based distributed authoring and versioning (WebDAV) compatibility, a configuration database disposed on the server, wherein the configuration database stores the configuration information, and a communication interface for facilitating communication between the configuration database and the application server, wherein the application server includes instructions for accessing the configuration database for retrieving configuration information.

Additional representative embodiments are directed to a method for providing configuration information to one or more application servers from a WebDAV-compliant computing system, the method comprising accessing the WebDAV-compliant computing system, requesting the configuration information from a configuration repository located within the WebDAV-compliant computing system, and receiving the configuration information at the one or more application servers responsive to results of the requesting step.

Additional representative embodiments are directed to a system for providing configuration data to at least one application server from a server system having distributed authoring and versioning capabilities, the system comprising means for accessing the server system, means for requesting the configuration data from a configuration store located within the server system, and means for receiving the configuration data at the at least one application server responsive to results of the requesting means.

Additional representative embodiments are directed to a computer program product having a computer readable medium with computer program logic recorded thereon, the computer program product comprising code for accessing a server system having distributed authoring and versioning capabilities, code for requesting configuration data from a configuration store located within the server system, and code for receiving the configuration data at the at least one application servers responsive to results of the requesting code.

### BRIEF DESCRIPTION OF THE DRAWINGS

FIG. 1 is a block diagram illustrating an example configuration of a configuration repository implemented according to an embodiment of the teachings herein;

FIG. 2 is a block diagram illustrating an example configuration repository implemented according to an embodiment of the teachings herein;

FIG. 3 is a block diagram illustrating an example configuration repository implemented according to an embodiment of the teachings herein including representative examples of site managers;

FIG. 4 is a flow chart illustrating steps in accordance with the teachings of representative embodiments described herein; and

FIG. 5 depicts a block diagram of a computer system which is adapted to use the representative embodiments described herein.

### DETAILED DESCRIPTION

Web-based Distributed Authoring and Versioning (WebDAV) is a set of extensions to Hypertext Transfer Protocol (HTTP) that allows editing documents on a remote Web server. WebDAV provides support for: editing functions, such as creating, updating, deleting, and the like; properties, such as titles, authors, publication dates, and the like; collection functions, such as file system directories, desktop folders, and the like; and locking, which prevents the confusion and data corruption caused by two or more people editing the same content at the same time. WebDAV is platform independent, both in terms of client and server. Thus, users may generally have any type of operating system platform, such as APPLE COMPUTER CORPORATION'S MACINTOSH™ platform, MICROSOFT CORPORATION'S WINDOWS™ platform, UNIX or UNIX-based platforms, or the like, and interact with Web documents hosted on any type of WebDAV-compliant application servers.

Because WebDAV is merely a set of extensions to HTTP, many tools already exist that can build and support HTTP and, thus, WebDAV functionality. Furthermore, because HTTP is currently the language of the Web, firewalls and other Internet appliances and/or hardware do not generally cause access problems for WebDAV-enabled applications. Security methods from HTTP are also leveraged into WebDAV, thus many different levels of security may be utilized in the shared/versioned environment.

FIG. 1 is a block diagram illustrating an example configuration of a configuration repository implemented according to an embodiment of the teachings herein. Application servers 100 and 101 are configured into cluster 10. Application servers 100 and 101 preferably communicate with server 11 to perform various functions of the server logic, such as database searching, logic processing, or the like. Application servers 100 and 101 may have a preexisting relationship with server 11 or may establish a relationship at runtime. Because server 11 is WebDAV-compliant, it includes specific functions such as an authorization manager, version manager, search engine, and the like. If one or more of application servers 100 and 101 goes down or requires resetting, either one may preferably access configuration store 102 to request the necessary configuration information. Because the WebDAV capability keeps track of each accessing entity and each version of any particular document and can also control the access that each entity has to any document or any version of the documents, configuration store 102 may provide the appropriate configuration information for that particular requesting application server without requiring user input. For example, if one application server uses a prior version of configuration software and another application server uses a current version, configuration store 102 may provide both versions to the application servers either automatically (i.e., by keeping track of each application server and its appropriate version) or by executing a search requested by the accessing application server for a particular version.

The communication methodology between application servers 100 and 101 and configuration store 102 is relatively simple, considering that the WebDAV functionality is leveraged from standard HTTP. Therefore, no special interfaces, drivers, or complicated management programs are needed to facilitate the configuration management process. The WebDAV specification defines capabilities, such as version management and access control, allowing the ability to limit the access rights of a given principal on a given resource or version of a resource. These features of WebDAV are leveraged by the configuration system in its provision of a standardized way for accessing and managing configuration information from a central repository. This allows users to leverage existing tools, such as MICROSOFT INTERNET EXPLORER™ browser, MICROSOFT'S WINDOWS 2000™ operating system, and the like, for accessing WebDAV repositories.

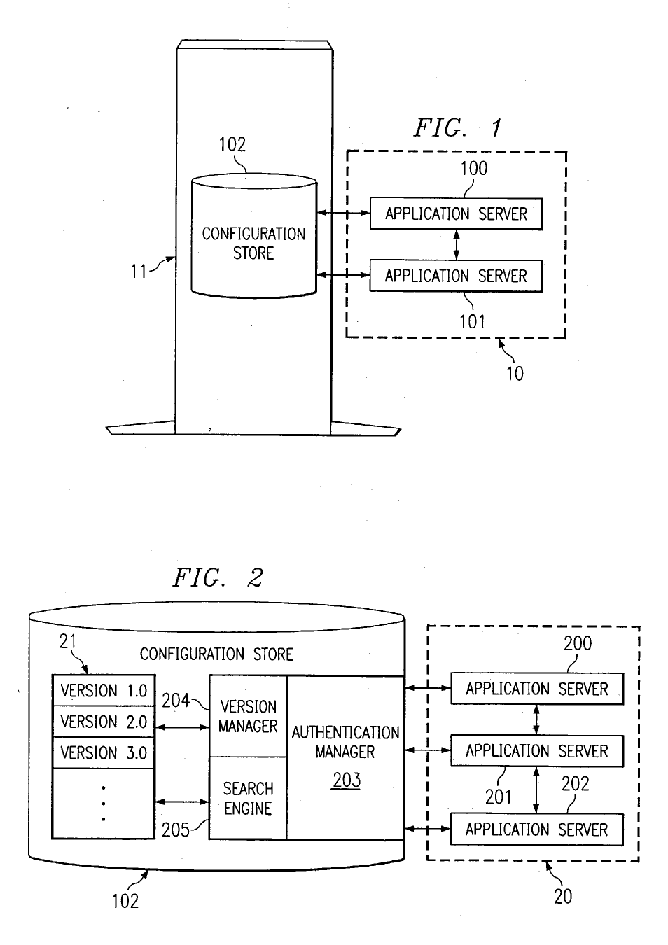

In addition to its file-sharing and versioning management capabilities, WebDAV provides capabilities for searching the WebDAV-enabled environment for selected documents or resources. Thus, an application requiring configuration information may preferably access a configuration repository in a WebDAV-enabled server system and search for the appropriate configuration data for that application server. FIG. 2 is a block diagram illustrating an example configuration repository implemented according to an embodiment of the teachings herein. Application servers 200-202 are clustered together in cluster 20. The configuration data of cluster 20 is found on configuration store 102. In the example embodiment shown, application server 200 uses a first version of the configuration data, application server 201 uses a second version, and application server 202 uses a third version. It should be noted that there is no limitation to the particular version that any given application server may use. Furthermore, multiple servers may use the same configuration version. The described embodiment supports any different combination of supplying configuration data to multiple application servers.

In one possible example operation, consider a scenario in which application server 200 may fail and require resetting. As a part of its programming, application server 200 is preferably instructed to communicate with configuration store 102. After providing the necessary authentication information to authentication manager 203, application server 200 makes a query for configuration information Version 1.0. By preferably interpreting the WebDAV HTTP extension making such search request, configuration store 102 preferably searches configuration database 21 for Version 1.0 using search engine 205. Upon successfully finding Version 1.0, configuration store 102 preferably returns Version 1.0 to application server 200 for resetting its configuration.

In a second possible example operation, consider a scenario in which application servers 201 and 202 each fail and require resetting. As a part of their programming, they are preferably instructed to communicate with configuration store 102. After providing the necessary authentication information to authentication manager 203, Version manager 204 leverages the WebDAV versioning and access capabilities to find the appropriate configuration information in configuration store 102 that is associated with each of application servers 201 and 202. Unlike the previously described example operation, which utilized the searching capability of search engine 205, the authentication information preferably allows version manager 204 to match the appropriate configuration information in configuration store 102 with the appropriate application server. For example, the authentication information for application server 201 may indicate that it uses Version 2.0. Therefore, version manager 204 preferably allows configuration store 102 to communicate Version 2.0 to application server 201. Similarly, the authentication information for application server 202 may indicate that it uses Version 3.0, in which case version manager 204 preferably allows communication of that version to application server 202.

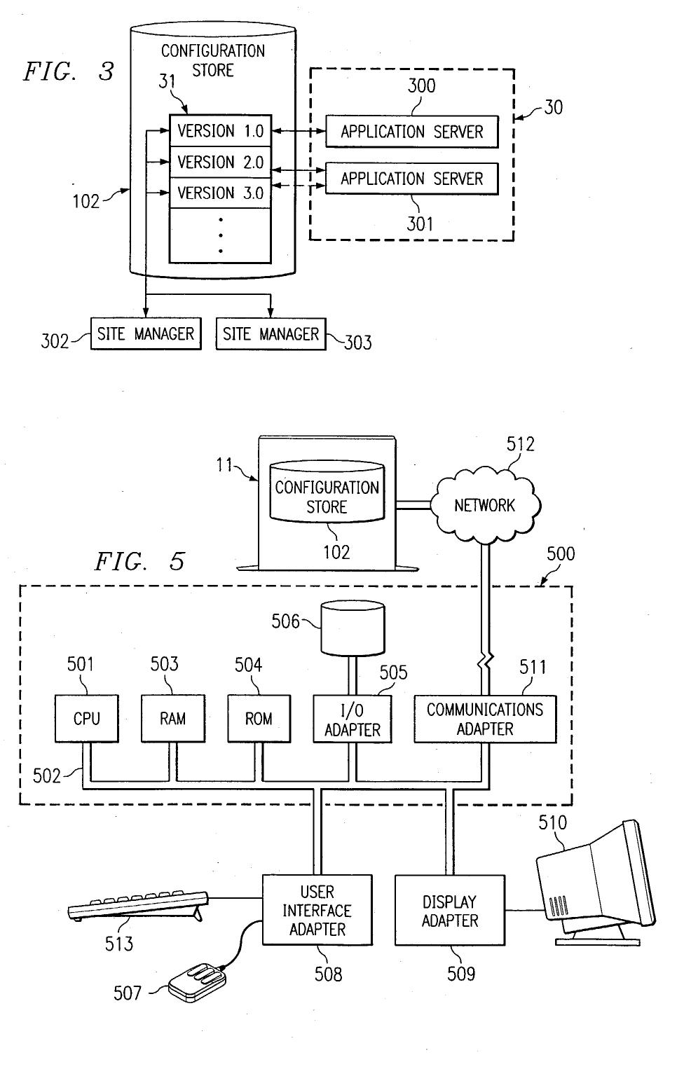

It should be noted that because of WebDAV's extensive capabilities for versioning management, access management, and searching, any different combinations of access means may preferably be provided for in the accessing application servers. Furthermore, because of the distributed authoring capabilities of WebDAV, any additions, changes, or corrections to the configuration information may preferably be implemented by one or more remote accessing site managers without the necessity of completely re-loading all of the configuration information. FIG. 3 is a block diagram illustrating an example configuration repository implemented according to an embodiment of the teachings herein including representative examples of site managers 302 and 303. Application servers 300 and 301 are related together to form cluster 30. Configuration store 102 serves application servers 300 and 301 with configuration information when necessary. If either or both of application servers 300 and 301 require configuration information, each may preferably contact configuration store 102 and submit its authentication information in order for configuration store 102 to determine which version of the configuration information stored in configuration database 31 to return.

If a version of the configuration information would need to be changed, site managers 302 and/or 303 may preferably access configuration database 31 to change any one or more of the different versions. For example, site manager 302 may access Version 1.0 to change one parameter, may access Version 2.0 to change another parameter, and may create Version 3.0 either from scratch or from some variations of the other two. By leveraging the locking and distributed editing environment capabilities of WebDAV, site manager 303 may also make changes and edits to any of the versions of configuration information in configuration database 31 without jeopardizing the changes made by site manager 302. For example, site manager 303 may provide that application server 301 should change its configuration information from Version 2.0 to Version 3.0. In so doing, the next time that application server 301 accesses configuration store 102, Version 3.0 of the configuration information will preferably be forwarded to application server 301. Therefore, the embodiments that incorporate the teachings of the present invention may preferably be edited and updated in a distributed manner by leveraging the distributed editing environment present in WebDAV-enabled servers.

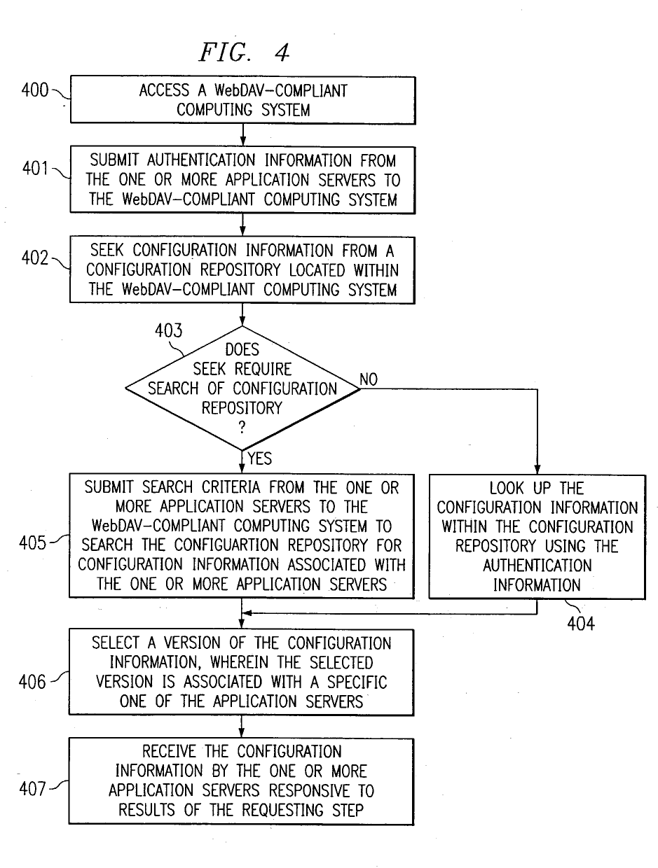

FIG. 4 is a flow chart illustrating steps in accordance with the teachings of representative embodiments described herein. In step 400, one or more application servers accesses a WebDAV-compliant computing system. In step 401, the one or more application servers submit authentication information to the WebDAV-compliant computing system. In step 402, the application servers seeks the configuration information from a configuration repository located within the WebDAV-compliant computing system. In step 403, when the WebDAV-compliant computing system receives the communication from the one or more application servers, it determines whether the application server is requesting a search for the appropriate configuration information or whether the computing system will automatically find the configuration data using the application server's authentication information. The WebDAV-compliant computing system may then look up the configuration information within the configuration repository using the authentication information in step 404. Alternatively, in step 405, the application servers may submit search criteria to the WebDAV-compliant computing system to search the configuration repository for configuration information associated with the one or more application servers. In step 406, the WebDAV-compliant computing system selects a version of the configuration information, wherein the selected version is associated with a specific one of the application servers. In step 407, the one or more application servers receive the configuration information responsive to results of the requesting step.

When implemented in software, the elements of the present invention are essentially the code segments to perform the necessary tasks. The program or code segments can be stored in a processor readable medium or transmitted by a computer data signal embodied in a carrier wave, or a signal modulated by a carrier, over a transmission medium. The “processor readable medium” may include any medium that can store or transfer information. Examples of the processor readable medium include an electronic circuit, a semiconductor memory device, a ROM, a flash memory, an erasable ROM (EROM), a floppy diskette, a compact disk CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc.

FIG. 5 depicts a block diagram of computer system 500 which is adapted to use the representative embodiments described herein. Central processing unit (CPU) 501 is coupled to system bus 502. CPU 501 may be any general purpose CPU, such as an HP PA-8500 or Intel Pentium processor or the like. However, the representative embodiments described herein are not restricted by the architecture of CPU 501, as long as CPU 501 supports the operations as described herein. Bus 502 is coupled to random access memory (RAM) 503, which may be SRAM, DRAM, or SDRAM. ROM 504 is also coupled to bus 502, which may be PROM, EPROM, or EEPROM. RAM 503 and ROM 504 hold user and system data and programs as is well known in the art.

Bus 502 is also coupled to input/output (I/O) controller card 505, communications adapter card 511, user interface card 508, and display card 509. The I/O adapter card 505 connects to storage devices 506, such as one or more of a hard drive, a CD drive, a floppy disk drive, a tape drive, to the computer system. Communications card 511 is adapted to couple computer system 500 to network 512, which may be one or more of a telephone network, a local (LAN) and/or a wide-area (WAN) network, an Ethernet network, and/or the Internet network. User interface card 508 couples user input devices, such as keyboard 513, pointing device 507, and or the like, to computer system 500. Display card 509 is driven by CPU 501 to control the display on display device 510.

In operation, an application server may be deployed on computer system 500. The computer program logic may be stored on storage device 506. When the application server is accessed the program logic is processed by CPU 501. Thus, the application server may access server 11 through network 512 using communication adapter 511 of computer system 500. After establishing a communication link between server 11 and computer system 500, the application server running on computer system 500 may communicate authentication information, search criteria, or the like in order to receive the appropriate configuration data from configuration store 102.

1. A system for providing configuration information to an application server comprising:
a server, wherein said server includes web-based distributed authoring and versioning (WebDAV) compatibility;
a configuration database disposed on said server, wherein said configuration database stores said configuration information; and
a communication interface for facilitating communication between said configuration database and said application server, wherein said application server includes instructions for accessing said configuration database for retrieving configuration information.

2. The system of claim 1 further comprising:
at least one site manager for managing at least one of:
said application server; and
said configuration information.

3. The system of claim 1 further comprising:
an authentication manager operable by said server, wherein said authentication manager processes authentication information communicated by said application server.

4. The system of claim 3 further comprising:
a version manager operable by said server, wherein said versioning manager determines a version of said configuration information associated with said application server responsive to said authentication information.

5. The system of claim 1 further comprising:
a search engine operable by said server to facilitate a search initiated by said application server for configuration information stored in said configuration database.

6. A method for providing configuration information to one or more application servers from a web-based distributed authoring and versioning (WebDAV)-compliant computing system, said method comprising:
accessing said WebDAV-compliant computing system;
seeking said configuration information from a configuration repository located within said WebDAV-compliant computing system; and
receiving said configuration information at said one or more application servers responsive to results of said requesting.

7. The method of claim 6 further comprising:
submitting authentication information from said one or more application servers to said WebDAV-compliant computing system prior to said requesting.

8. The method of claim 7 further comprising:
looking up said configuration information within said configuration repository using said authentication information.

9. The method of claim 6 further comprising:
submitting search criteria from said one or more application servers to said WebDAV-compliant computing system to search said configuration repository for configuration information associated with said one or more application servers.

10. The method of claim 6 further comprising:
selecting a version of said configuration information after said requesting, wherein said selected version is associated with a specific one of said one or more application servers.

11. A system for providing configuration data to at least one application server from a server system having distributed authoring and versioning capabilities, said system comprising:
means for accessing said server system;
means for requesting said configuration data from a configuration store located within said server system; and
means for receiving said configuration data at said at least one application server responsive to results of said requesting.

12. The system of claim 11 further comprising:
means for submitting authentication information from said at least one application server to said server system prior to said requesting.

13. The system of claim 12 further comprising:
means for looking up said configuration data within said configuration store using said authentication information.

14. The system of claim 11 further comprising:
means for submitting search criteria from said at least one application server to said server system to search said configuration store for configuration data associated with said at least one application server.

15. The system of claim 11 further comprising:
means for selecting a version of said configuration data after said requesting, wherein said selected version is associated with a specific one of said at least one application server.

16. A computer program product having a computer readable medium with computer program logic recorded thereon, said computer program product comprising:
code for accessing a server system having distributed authoring and versioning capabilities;
code for requesting configuration data from a configuration store located within said server system; and
code for receiving said configuration data at said at least one application servers responsive to results of said requesting code.

17. The computer program product of claim 16 further comprising:
code for submitting authentication information from said at least one application servers to said server system prior to said requesting code.

18. The computer program product of claim 17 further comprising:
code for looking up said configuration data within said configuration store using said authentication information.

19. The computer program product of claim 16 further comprising:
code for submitting search criteria from said at least one application servers to said server system to search said configuration store for configuration data associated with said at least one application servers.

20. The computer program product of claim 16 further comprising:
code for selecting a version of said configuration data after said requesting step, wherein said selected version is associated with a specific one of said at least one application servers.
